(19) United States
(12) Patent Application Publication
(10) Pub. No.: US 2006/0192448 A1
(43) Pub. Date: Aug. 31, 2006

(54) Electric actuation and process for making the same

(75) Inventor: Wolfgang Hill, Karlsruhe (DE)

Correspondence Address: DAVIDSON, DAVIDSON & KAPPEL, LLC, 485 SEVENTH AVENUE, 14TH FLOOR, NEW YORK, NY, 10018, US

(73) Assignee: LUK LAMELLEN UND KUPPLUNGSBAU BETEILIGUNGS KG, Buehl (DE)

(21) Appl. No.: 11/349,868

(22) Filed: Feb. 8, 2006

(30) Foreign Application Priority Data
Feb. 8, 2005 (DE) DE 102005005853.1

(51) Int. Cl. H02K 1/04; H02K 5/10

(52) U.S. Cl. 310/88; 310/43; 29/596

(57) ABSTRACT

In a method for manufacturing an electric drive, an electric motor having a stator, a drive electronics for the winding of the electric motor, and a housing are provided. Before being installed in the housing, the drive electronics and the stator are positioned against each other. Connection points of the drive electronics are electrically connected to the winding of the electric motor. A sealing compound is then brought into contact with the stator and the drive electronics and thereby joins the drive electronics to the stator. The sealing compound is subsequently solidified. Thus, the formed subassembly made up of the stator, the drive electronics and the sealing compound is installed in the interior cavity of the housing.

### CROSS REFERENCE TO RELATED APPLICATION

This application claims the benefit of German Patent 10 2005 005 853.1 filed Feb. 8, 2005 and hereby incorporated by reference herein.

The present invention provides a method for manufacturing an electric drive, an electric motor having a stator, a drive electronics for the winding of the electric motor, and a housing being provided, the electric motor and the drive electronics being installed in an interior cavity of the housing, and connection points of the drive electronics being electrically connected to the winding of the electric motor. The present invention also provides an electric drive having an electric motor including a stator, and having a drive electronics for the winding of the electric motor, the electric motor and the drive electronics being placed in the interior cavity of a housing.

### BACKGROUND OF THE INVENTION

An electric drive of this kind used for a cordless screwdriver and a method for manufacturing the drive are known from European Patent No. 0 293 706 B1. The drive has a metallic housing part fabricated as an extruded profile, in which two receiving chambers are formed, whose principal planes of extension disposed more or less in parallel to one another are separated by an intermediate wall. Disposed axially one behind the other in one of the receiving chambers is an electric motor having a cylindrical motor housing and a gear unit that is operatively connected to the electric motor. The drive electronics is provided in the other receiving chamber. The electric motor and the drive electronics are interconnected by electrical lines which are routed through a feed-through orifice provided in the intermediate wall.

When manufacturing the electric drive, the electric motor and the drive electronics are first introduced into their respective receiving chamber. The wall of the receiving chamber accommodating the electric motor is provided with an inwardly projecting, circumferential stop shoulder which functions as a limit stop when the electric motor is introduced. The drive electronics has a circuit board which is positionally fixed in the receiving chamber provided for the drive electronics. Following insertion of the electric motor and the drive electronics, the electrical lines are connected to the electric motor, the drive electronics, and to a socket connector part provided on an end cover. The end cover is then placed on the housing part and bolted thereto. The electric motor and the drive electronics are axially fixed in the housing part by the end cover. The gear unit is subsequently introduced from the opposite side of the housing part and anchored in the same.

The drawback associated with the electric drive is that the housing having the receiving chambers requires a relatively substantial amount of space. Moreover, the interplay of the electrical components, namely of the electric motor and the drive electronics, cannot be tested until the final assembly operation is complete. The electrical components are typically delivered by a supplier to a final-assembly plant. If a fault is detected in the drive electronics when performing the functional test after the final assembly operation, it is typically no longer possible to easily determine whether the drive electronics had already been defective at delivery, or whether the defect first came into existence during assembly, due to improper handling of the drive electronics, resulting, for example, in an electrostatic discharging. Moreover, once a fault is diagnosed in an electrical component of the drive, the already assembled drive must be disassembled in order to replace the defective component and, if necessary, returned to the manufacturing plant. Thus, a relatively substantial outlay is still entailed in manufacturing the electric drive.

### SUMMARY OF THE INVENTION

An object of the present invention is, therefore, to devise an electric drive and a method of the type mentioned at the outset which will allow the electrical components (drive electronics, electric motor) to be installed in the housing in a simple and reliable final assembly operation.

The present invention provides a method including positioning the drive electronics and the stator against each other before installing them in the housing; bringing a sealing compound into contact with the stator and the drive electronics, joining the drive electronics to the stator; subsequently allowing the sealing compound to set; and introducing the thus formed subassembly made up of the stator, the drive electronics and the sealing compound into the interior cavity of the housing.

In the process, the sealing compound preferably adheres to the stator and to the drive electronics, joining them to form a mechanically stable subassembly. A sealing compound is understood to be a flowable, settable substance, such as plastic, adhesive or rigid foam. The solidification process may be carried out as a curing process, for example by evaporation of a solvent contained in the flowable compound, by a chemical reaction between at least two components contained in the flowable compound, and/or by cooling and setting of the compound.

The present invention advantageously may make it possible for all of the electrical components of the drive to be tested already in advance, before they are introduced into the housing, so that defective components never make it to the final assembly stage in the first place. Thus, in the case of a defect in an electrical component, unnecessary assembly and disassembly work is avoided right from the start. If the electrical components undergo a 100% functional test before being installed in the housing, and the drive still exhibits a fault following the final assembly, then the assumption must be this fault first came into existence in the final-assembly plant. Thus, responsibility for the fault may be clearly attributed to the manufacturer of the electrical subassembly or to the company which performs the final assembly operation.

The drive electronics is preferably positioned next to the stator in such a way that at least one clearance space is formed between this stator and the drive electronics, this clearance space being bridged by or filled with the sealing compound. The sealing compound preferably exhibits a low thermal conductivity, so that it thermally insulates the drive electronics from the winding of the electric motor. Thus, a compact design of the electric drive is facilitated by the method.

One advantageous embodiment of the present invention may provide for the drive electronics to be positioned next to one end face of the stator in such a way that it faces opposite the winding heads of the winding, thereby forming the clearance space between the winding heads and the drive electronics. Thus, the drive electronics is axially offset from the stator of the electric motor, which, in particular, makes more compact electric drive dimensions feasible.

With regard to an electric drive of the type mentioned at the outset, the present invention provides that the stator and the drive electronics are permanently joined together by a solidified sealing compound, forming a subassembly.

This may make it possible to test the electrical subassembly in advance, to check if it is fully operational, before introducing it into the housing, thereby economizing assembling the subassembly in the housing, in the case of a defect. A simple and rapid final assembly in the housing also may be facilitated by the prefabricated electrical subassembly. By using the sealing compound, joints or assembly gaps, which would permit the ingress of moisture or other liquids, are prevented from forming.

It may be beneficial for the subassembly to be detachably secured to the housing. Thus, the sealing compound may adhere only to the drive electronics and to the stator, for example to the stator's laminated core or to the winding. Should a malfunction of the electric drive occur, then the electrical subassembly may be easily separated from the housing and the defective part exchanged for a suitable replacement part.

It may be advantageous when a clearance space is formed between the stator and the drive electronics that is bridged by or filled with the sealing compound. In this context, the sealing compound preferably exhibits a low thermal conductivity, in order to thermally insulate the drive electronics from the winding.

One preferred embodiment of the present invention provides for the drive electronics to be positioned next to one end face of the stator, the clearance space being provided between the drive electronics and winding heads of the winding. An especially compact electric drive design may be made possible by this measure.

The drive electronics advantageously may have a circuit substrate, on whose front side electrical components are mounted and, on whose rear side, circuit traces connected to the components are provided, the front side of the circuit substrate facing the winding heads, and the rear side of the circuit substrate being connected thermoconductively to a heat dissipator. This enables the drive electronics to be positioned closer to the winding heads, any existing heat being transmitted from the winding heads through the thermally insulating sealing compound to the drive electronics or dissipation heat produced in the drive electronics being dissipated via the circuit substrate or the circuit traces to the heat dissipator.

It may be advantageous when the winding has a plurality of winding coils that are staggered over the circumference of the stator, when an interconnection board preferably designed as a lead frame, used to connect the winding coils to the phase connections of the drive electronics, is disposed between the winding heads and the circuit substrate, and when the clearance space bridged by or filled with the sealing compound is provided between the interconnection board and the circuit substrate. At the same time, the sealing compound also may function as a spacer element between the individual conductor parts of the lead frame. Naturally, the interconnection board may, however, also be designed as a circuit board having an electrically insulating back plane and circuit traces disposed thereon.

The circuit substrate preferably has an annular design, including an opening to allow a holding part supporting the stator or a spindle shaft connected to the rotor to extend through. Thus, a short and slim type of construction is made feasible by the electric drive.

In one preferred embodiment of the present invention, the electric motor may be designed as an external-rotor motor, the stator having a slotted laminated core for accommodating the winding coils, and the holding part or the spindle shaft being designed as a metallic thermal conductor that is thermoconductively connected to the laminated core and to a heat sink, in particular to the heat dissipator. This enables the heat losses produced in the winding to be dissipated via the laminated core having good thermal conducting properties, and the holding part or the spindle shaft and thus, past the drive electronics, directly to the heat sink. Thus, the stator and the drive electronics are cooled independently of one another.

A heat-conducting sleeve may be advantageously employed between the stator and the heat dissipator of the housing. One end face of the heat-conducting sleeve rests flat against the yoke of the stator, and the opposite end face of the heat-conducting sleeve rests flat against the heat dissipator. The heat-conducting sleeve is integrated in the sealing compound and, in addition to ensuring the flow of heat, it also provides the clearance space between the stator and the heat dissipator, as well as the anchoring of the electrical subassembly in the housing during assembly.

One advantageous embodiment of the present invention may provide for the drive electronics to include at least one preferably magnetic or inductive rotor-position encoder that is positioned in the solidified sealing compound or adheres to the same, preferably in such a way that it cooperates with at least one transmitter element mounted on the rotor. The sealing compound ensures that the positioning of the rotor-position encoder is precisely observed. A plurality of rotor-position encoders are preferably staggered over the circumference of the rotor in or on the sealing compound and are positioned at defined locations relative to each other by the sealing compound. The transmitter element may have at least one projection or a toothing, that is preferably integrally formed on a magnetically conductive yoke part of the rotor.

It may be advantageous when the housing has a more or less cup-shaped housing part, in whose interior cavity the electric motor is placed. The housing part may be fabricated inexpensively as a die-cut and bent sheet metal part.

In one useful embodiment of the present invention, the heat dissipator may be designed as a fastening flange which is attached to the side of the housing part facing opposite the base of the cup-shaped housing part. The fastening flange may then be joined to a holding part having good thermal conducting properties, thereby permitting an even more efficient dissipation of heat from the circuit substrate that is joined to the fastening flange.

In one preferred embodiment of the present invention, on the rear side of the circuit substrate, an electrical plug connector part having electrical connections for the drive electronics may be fastened to the circuit board or the circuit substrate, a through hole for the connector part being provided in the fastening flange. Thus, the plug connector part may already be tested in advance, along with the other electrical components of the subassembly, before being introduced into the housing. By directly attaching the plug connector part to the circuit substrate, a short electrical lead to the drive electronics is made possible, so that a good EMC (electromagnetic compatibility) shielding of the drive electronics is provided. The electrical connections may also be routed from the circuit substrate, laterally to the outside of the housing, with the result that the plug connector part is mounted on the peripheral surface, outside of the electric motor.

It may be advantageous when a gear unit that is operatively connected to the electric motor is placed in the interior cavity of the housing. The gear unit may be used to increase or reduce the speed of the electric motor to a speed value that is favorable for the particular application.

In one preferred embodiment of the present invention, the gear unit may have a wound spring, which is preferably positioned between a peripheral wall of the housing part and the electric motor, around the same, at least one engagement element, which engages between two mutually adjacent windings of the spring, being connected to the rotor of the electric motor. In the context of a compact design and a high transmission ratio, a gear unit of this kind permits a low-friction translation of the rotary motion of the rotor into a linear motion. Moreover, since the gear unit is able to transmit high axial loads, the electric drive may be used as a control device for electrically adjusting the ride-height level of a motor-vehicle body.

### BRIEF DESCRIPTION OF THE DRAWINGS

An exemplary embodiment of the present invention is explained in greater detail in the following with reference to the drawing, in which:

FIG. 1 shows a view of the front side of a circuit board, populated with electrical components, for a drive electronics;

FIG. 2 illustrates a longitudinal section through a subassembly, which includes a stator and a drive electronics, for an electric drive that has been placed in a mold tool into which a sealing compound has been introduced;

FIG. 3 illustrates a longitudinal section through the subassembly which has been removed from the mold tool following solidification of the sealing compound;

FIG. 4 illustrates a longitudinal section along a radial plane of an electric device for controlling a device used for adjusting the suspension and ride height of motor vehicles;

FIG. 5 shows a representation similar to FIG. 4, the spacing between the flange and the cup-shaped housing part of the electric drive being enlarged in comparison to FIG. 4;

FIG. 6 shows a sleeve element having engagement elements disposed thereon for a gear spring;

FIG. 7 depicts a rotor part of the electric drive; and

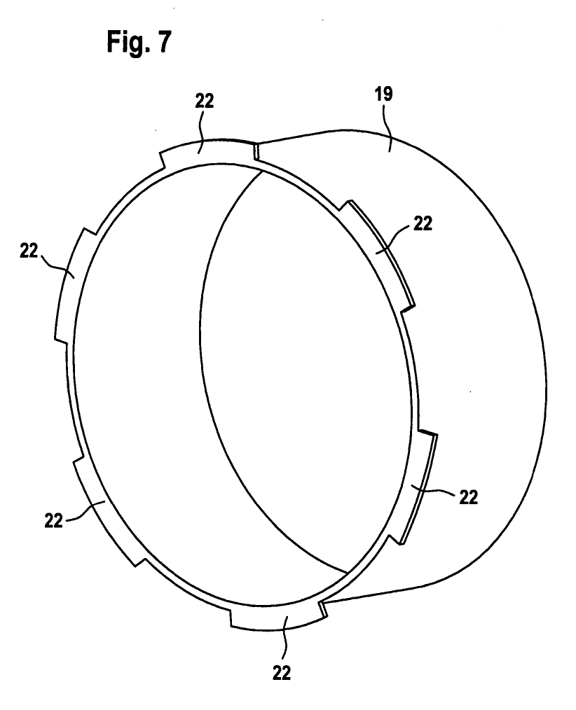

FIG. 8 shows a side view of a gear spring, between whose windings engagement elements engage.

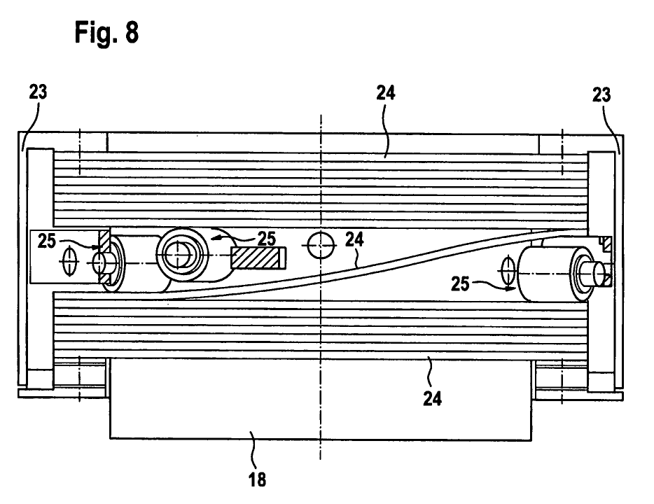

### DETAILED DESCRIPTION OF A PREFERRED EMBODIMENT

In a method for manufacturing an electric drive 1, a stator and a rotor are provided for an electric motor. The stator has a laminated core 2 and a winding which has a plurality of winding coils that are offset from one another in a circumferential direction of laminated core 2, the winding coils resting in slots of laminated core 2 and projecting with a plurality of their windings heads 3 past axial ends of laminated core 2. A drive electronics 4 for the winding and an interconnection board 5 are also provided.

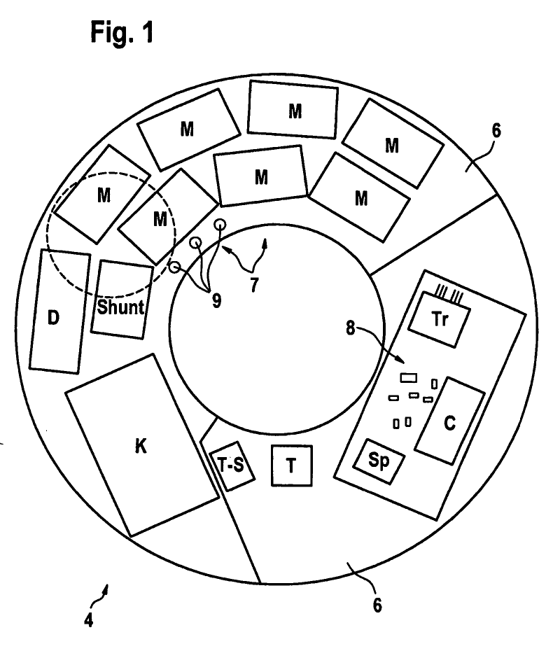

Interconnection board 5 has a plurality of electrical conductors with a plurality of terminal contacts that are connectable to coil ends of the individual winding coils or to connection points of drive electronics 4. In FIG. 1, drive electronics 4 has a circuit substrate 6, which may be formed as a multilayer circuit board or as a plastic-coated lead frame having hybrid ceramics attached thereto. Electrical components for an output stage 7 and a control logic 8 for driving output stage 7 are mounted on the circuit substrate.

FIG. 1 shows semiconductor switches M of the output stage and a microcontroller C of control logic 8. A shunt for measuring a winding current is provided on circuit substrate 6. A reactance coil forming an input filter and a back-up capacitor are preferably mounted on circuit substrate 6 in the vicinity of the plug connector (dashed-line circle) attached to a rear side.

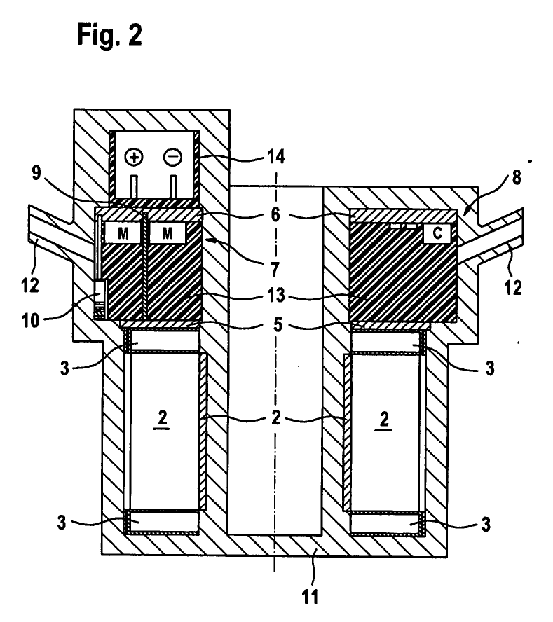

In FIG. 2, laminated core 2, along with the winding disposed thereon, interconnection board 5, the circuit board having the electrical components mounted thereon, and rotor-position encoders 10 are introduced into a mold cavity of a multipart mold tool 11, which is movable into an open and a closed position, and are able to be fixed relative to each other in the mold cavity, by retaining means in their later position of normal use.

The front side of circuit substrate 6 having the electrical components faces winding heads 3 of the stator. Interconnection board 5 is located between circuit substrate 6, i.e., the electrical components disposed thereon, and winding heads 3. The plane of extension of interconnection board 5 extends approximately normally to the longitudinal axis of the stator. The coil ends are welded or soldered to terminal contacts of interconnection board 5. Moreover, terminal contacts, corresponding in number to the phases of the electric motor, are each connected to their assigned a connection point 9 of drive electronics 4.

A clearance space, by which circuit substrate 6 and the components are spaced apart from winding heads 3 in the axial direction of the stator, is formed between circuit substrate 6 and, respectively, the electrical components located thereon, and interconnection board 5.

Once mold tool 11 is closed, a liquid or flowable sealing compound 13 is introduced via feed channels 12 provided in mold tool 11, into the mold cavity, thereby preferably completely filling the free space. A negative pressure is advantageously generated in a hollow space of the mold tool prior to introducing a sealing compound 13. Thus, sealing compound 13 penetrates into the smallest gap, even in the stator, without forming any air inclusions. As shown in FIG. 2, circuit substrate 6 is positioned with its rear side imperviously against the interior wall of mold tool 11, to ensure that the rear side of circuit substrate 6 is not coated with sealing compound 13. Alternatively, sealing compound 13 may be introduced at the lower winding head, without producing any swirl effect, the liquid level rising against the force of gravity through the entire subassembly up to circuit substrate 6. The sealing compound also fills all hollow spaces in the stator and thus improves its dielectric strength.

In FIG. 2 at a front side of circuit substrate 6, sealing compound 13 bridges the clearance space between circuit substrate 6 and, respectively, the components located thereon, and the stator. Sealing compound 13 adheres to circuit substrate 6, to the electrical components located thereon, to laminated core 2, and to the winding. Fastened to the rear side of circuit substrate 6 is an electrical plug connector part 14 having electrical terminals for the drive electronics, namely current supply terminals and communication terminals.

Once the mold cavity is filled with sealing compound 13, sealing compound 13 is solidified. When working with a thermoplastic sealing compound 13, this may be achieved by introducing sealing compound 13 at a temperature higher than the maximum permissible operating temperature of the drive electronics, into the mold cavity, and then cooling the same to a temperature below the melting point of sealing compound 13. Once drive electronics 4 and the stator are permanently joined together in this manner to form a subassembly, mold tool 11 is opened to allow the subassembly to be removed or ejected from the same.

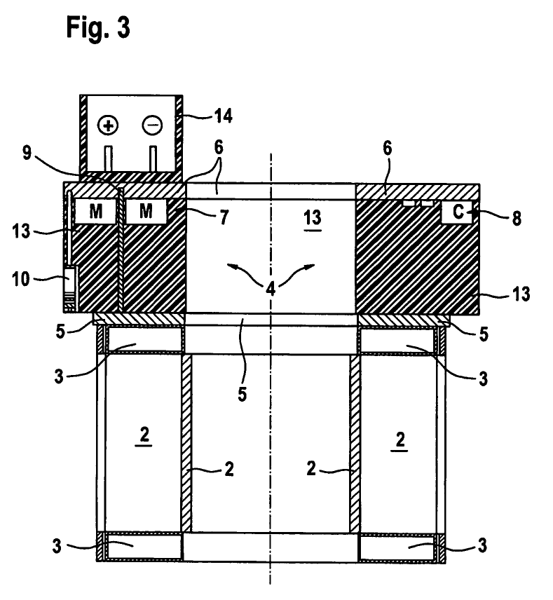

The thus obtained electrical subassembly shown in FIG. 3 may be subjected to a functional test as needed, for example, by rotationally mounting a test rotor on the subassembly to coact across an air gap with a traveling magnetic field produced in response to energization of the winding by drive electronics 4.

In another method step, the finished and, as the case may be, tested electrical subassembly is pressed via the rear side of circuit substrate 6 against a metallic heat dissipator 15 designed as a flange, of a housing, thereby forming a connection having good thermal conducting properties between circuit substrate 6 and heat dissipator 15. To compensate for tolerances, a heat-conducting foil or a heat-conducting paste is introduced between heat dissipator 15 and circuit substrate 6. A through hole, through which connector part 14 disposed on the rear side of circuit substrate 6 is introduced, is provided in the fastening flange.

Laminated core 2 of the stator has a more or less centrally located, axially extending positioning opening. When mounting the electrical subassembly on heat dissipator 15, the inner circumferential wall of the positioning opening is pressed against a sleeve-shaped holding part 16, which is positioned with its longitudinal axis approximately normally to the plane of extension of heat dissipator 15 and is permanently joined thereto, for example by a weld seam. However, it is also conceivable for holding part 16 to be integrally formed with heat dissipator 15. Holding part 16 is designed as a metallic thermal conductor that provides an efficient thermoconductive connection between laminated core 2 and heat dissipator 15 used as a heat sink. In FIGS. 1, 4 and 5 circuit substrate 6 has a more or less circular design, including a central opening through which holding part 16 extends.

In another method step, a bearing 17, which is located in a sleeve element 18, is pressed onto the unattached end of holding part 16. An outer bearing ring of bearing 17 is positively connected to the inner wall of sleeve element 18. Inserted into sleeve element 18 is a sleeve-shaped rotor part 19, on whose inner circumferential wall at least one permanent magnets 20 are adhesively bonded, which cooperate with the winding of the stator when the drive is fully assembled. The rotor has a rotor part 19 and a sleeve element 18 and is rotationally driven relative to the stator.

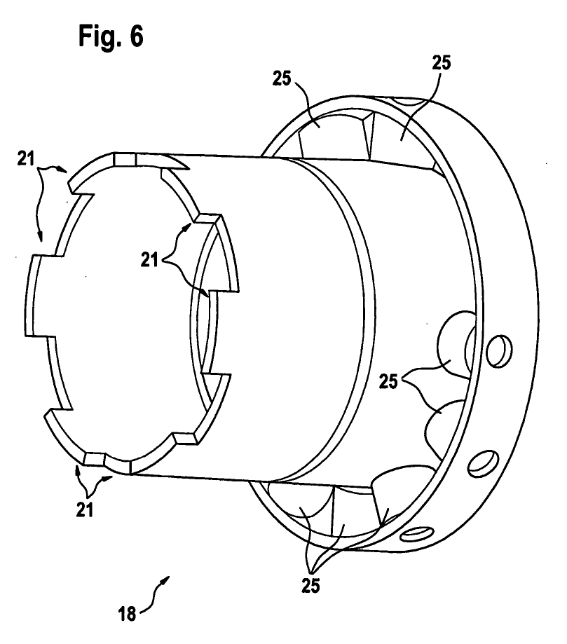

In FIG. 6 sleeve element 18 has a crown-type toothing 21 at its end facing the drive electronics. Provision is made on rotor part 19 for projections 22, which engage in the tooth gaps of toothing 21 and torsionally lock together rotor part 19 and sleeve element 18. In addition, toothing 21 functions as a transmitter for rotor-position encoders 10 which axially oppose it and are located in an outer peripheral layer of sealing compound 13.

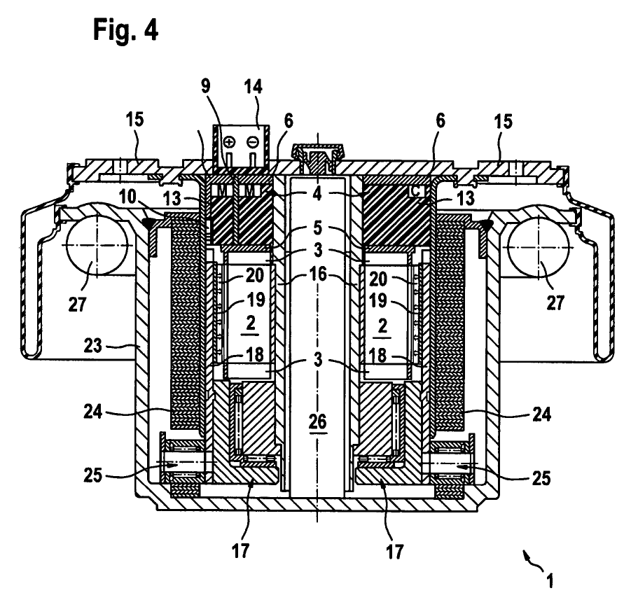

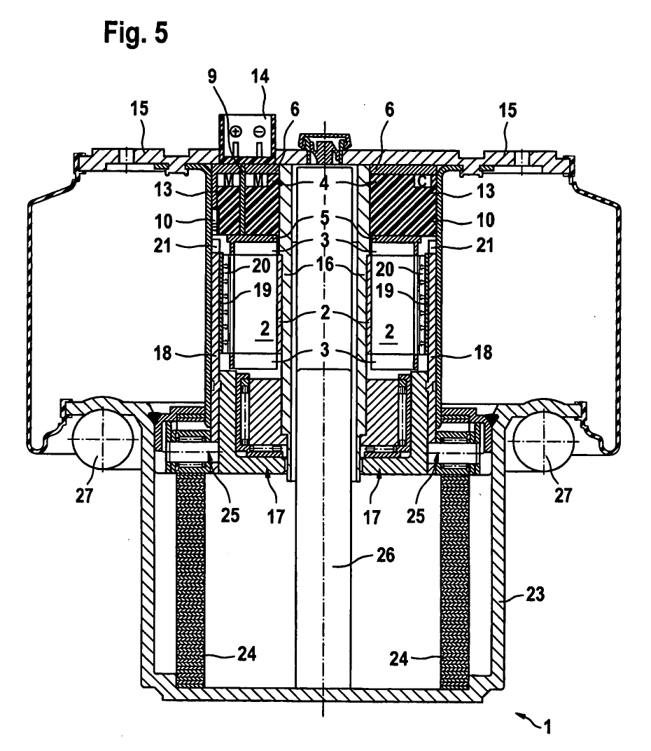

Thus, the obtained electric motor is introduced into the interior cavity of an approximately cup-shaped housing part 23, which, at its base, on the inside, has a guide pin 26 on which sleeve-shaped holding part 16 is axially displaceable. Disposed in the interior cavity is a wound spring 24 which encircles sleeve element 18. On its periphery, the latter has more or less radially projecting engagement elements 25, which engage between the windings of spring 24. Spring windings, which are spaced apart by engagement elements 25, are at the limit stop position. A spring 24 is axially braced by its one end against the base of housing part 23 and by its other end against an annular cover member welded to housing part 23. As shown in FIGS. 4 and 5, the rotary motion of the rotor is translated into a linear motion by the gear unit made up of spring 24 and engagement elements 25 located on sleeve element 18. Housing part 23 rests with its outer edge on a coil of a suspension spring 27 of a motor vehicle. Heat dissipator 15 is connected to the bodyshell of the vehicle.

Thus, in the method for manufacturing an electric drive, an electric motor having a stator, a drive electronics 4 for the winding of the electric motor, and a housing are provided. Before being installed in the housing, drive electronics 4 and the wound stator are positioned against each other. Connection points of drive electronics 4 are electrically connected to the winding of the electric motor. A sealing compound 13 is brought into contact with the stator and with drive electronics 4 and thereby joins drive electronics 4 to the stator. Sealing compound 13 is subsequently solidified. The formed subassembly made up of the stator, drive electronics 4 and sealing compound 13 is installed in the interior cavity of the housing.

### REFERENCE NUMERAL LIST

1 electric drive
2 laminated core
3 winding head
4 drive electronics
5 interconnection board
6 circuit substrate
7 output stage
8 control logic
9 connection point
10 rotor-position encoder
11 mold tool
12 feed channel
13 sealing compound
14 plug connector part
15 heat dissipator
16 holding part
17 bearing
18 sleeve element
19 rotor part
20 permanent magnet
21 toothing
22 projection
23 housing part
24 spring
25 engagement element
26 guide pin
27 suspension spring

What is claimed is:

1. A method for manufacturing an electric drive, the electric drive including an electric motor having a stator, the stator including a winding, a drive electronics for the winding, and a housing having an interior cavity, the electric motor and drive electronics being located in the interior cavity, the drive electronics having connection points electrically connected to the winding, the method comprising:
positioning the drive electronics and the stator against each other and electrically connecting them before being installed in the housing;
bringing a sealing compound into contact with the stator and with the drive electronics to join the drive electronics to the stator, subsequently solidifying the sealing compound; and
installing a subassembly defined by the stator, the drive electronics, and the solidified sealing compound in the interior cavity of the housing.

2. The method as recited in claim 1 wherein the sealing compound bridges or fills a clearance space between the drive electronics and the stator.

3. The method as recited in claim 1 wherein the drive electronics is positioned next to one end face of the stator so the drive electronics faces opposite winding heads of the winding, forming a clearance space between the winding heads and the drive electronics.

4. An electric drive comprising:
an electric motor including a stator having a winding, and
a drive electronics for the winding,
the electric motor and the drive electronics being located in an interior cavity of a housing;
the stator and the drive electronics being permanently joined together by a solidified sealing compound to form a subassembly.

5. The electric drive as recited in claim 4 wherein the subassembly is detachably secured to the housing.

6. The electric drive as recited in claim 4 wherein a sealing compound bridges or fills a clearance space between the stator and the drive electronics.

7. The electric drive as recited in claim 4 wherein the drive electronics is positioned next to one end face of the stator, a clearance space being located between the drive electronics and winding heads of the winding.

8. The electric drive as recited in claim 4 wherein the drive electronics includes a circuit substrate, electrical components mounted on a front side of the circuit substrate and circuit traces on a rear side of the circuit substrate, the circuit traces being connected to the electrical components, the front side facing winding heads of the winding and the rear side connecting thermoconductively to a heat dissipator.

9. The electric drive as recited in claim 4 wherein the winding includes a plurality of winding coils staggered over a circumference of the stator and further comprising an interconnection board connecting the winding coils to phase connections of the drive electronics, the interconnection board being disposed between the winding heads and a circuit substrate of the drive electronics, the sealing compound being provided in a clearance space between the interconnection board and the circuit substrate to bridge or fill the clearance space.

10. The electric drive as recited in claim 4 wherein the circuit substrate has an annular design and includes an opening to allow a holding part supporting the stator or a spindle shaft connected to a rotor to extend through the opening.

11. The electric drive as recited in claim 4 wherein the electric motor is an external-rotor motor; the stator has a slotted laminated core for accommodating the winding coils of the winding, and a holding part supporting the stator or spindle shaft of a rotor is designed as a metallic thermal conductor thermoconductively connected to a laminated core and to a heat sink of the stator.

12. The electric drive as recited in claim 4 wherein the drive electronics includes at least one rotor-position encoder positioned in the solidified sealing compound or adhering to the solidified sealing compound.

13. The electric drive as recited in claim 4 wherein the housing includes a cup-shaped housing part defining the interior cavity.

14. The electric drive as recited in claim 13 further comprising a heat dissipator designed as a fastening flange attached to a side of the housing part facing opposite a base of the cup-shaped housing part.

15. The electric drive as recited in claim 4 wherein the drive electronics includes a circuit substrate, an electrical plug connector part having connections for the drive electronics being fastened to a rear side of the circuit substrate, and the housing including a fastening flange with a a through hole for the electrial plug connector part.

16. The electric drive as recited in claim 4 further comprising a gear unit in the interior cavity of the housing and operatively connected to the electric motor.

17. The electric drive as recited in claim 16 wherein the gear unit includes a wound spring surrounding the gear unit and at least one engagement device engaging between two mutually adjacent windings of the spring and being connected to a rotor of the electric motor.

18. The electric drive as recited in claim 4 wherein the drive is a control device for electrically adjusting a ride-height level of a motor-vehicle body.

19. The electric drive as recited in claim 9 wherein the interconnection board is a lead frame.

20. The electric drive as recited in claim 12 wherein the encoder is a magnetic or inductive rotor-position encoder.

21. The electric drive as recited in claim 12 wherein the encoder cooperates with at least one transmitter element mounted on a rotor.

22. The electric drive as recited in claim 17 wherein the wound spring is positioned between a peripheral wall of the housing and the electric motor.
